(19) United States
(12) Patent Application Publication
(10) Pub. No.: US 2003/0067213 A1
(43) Pub. Date: Apr. 10, 2003

(54) Combination structure of a plastic wheel rim and wheel axle assembly of a bicycle

(75) Inventor: Chao-Ling Lin, Chang Hua Hsien (TW)

Correspondence Address: Harrison & Egbert, 7th Floor, 412 Main St., Houston, TX, 77002, US

(73) Assignee: Juh Feng Enterprise Co., Ltd.

(21) Appl. No.: 09/973,162

(22) Filed: Oct. 9, 2001

(51) Int. Cl. B60B 5/02

(52) U.S. Cl. 301/64.704

(57) ABSTRACT

A bicycle wheel structure comprises a main shaft tube, a shaft, a shaft pivoting member, a plastic wheel rim, and a wheel tire. The shaft is received in the main shaft tube in conjunction with the shaft pivoting member. The main shaft tube is provided in the side wall with a plurality of through holes via which a plastic inner tube is formed on the inner wall of the main shaft tube at the time when the plastic wheel rim is formed on the main shaft tube by injection molding. The inner tube serves as an anchorage to hold the plastic wheel rim firmly on to the main shaft tube. The plastic wheel rim is provided in the outer surface with a receiving slot which is in turn provided in the inner wall with a plurality of projections to retain the wheel tire that is mounted in the receiving slot.

### BACKGROUND OF THE INVENTION

1. Field of the Invention

The present invention relates generally to a bicycle, and more particularly to a combination structure of wheel rim and wheel axle assembly of the bicycle.

2. Description of Related Art

As shown in FIGS. 1-3, a bicycle combination structure of the prior art is formed of a wheel rim 10 and an axle assembly comprising a shaft 20 and a locating tube 2 1. The locating tube 21 is provided in the outer wall with a plurality of locating surfaces 211 for locating the plastic wheel rim 10 which is formed on the locating tube 21 by injection molding. The locating tube 21 is provided in the outer wall of two longitudinal ends with a plurality of threads 212 and an annular groove 213. The locating tube 21 is further provided in the inner wall of two longitudinal ends with an annular protrusion 214. The shaft 20 is located in the locating tube 21 in conjunction with two balls 24, 25, two bearings 26, 27, and two fastening nuts 26, 27. In addition, two bearing disks 22 and 23 are respectively forced into two longitudinal ends of the locating tube 21 such that the bearing disks 22 and 23 are stopped by the annular protrusions 214. A rubber tire 3 0 is mounted on the wheel rim 10.

Such a prior art structure as described above is defective in design in that the plastic wheel rim 10 is vulnerable to being separated from the locating surfaces 211 of the locating tube 21, thereby resulting in failure of the shaft 20 to drive synchronously the plastic wheel rim 10. This deficiency becomes more apparent in a situation in which the locating surfaces 211 of the locating tube 21 are not formed with precision.

The locating tube 21 of the prior art combination structure is rather complicated in construction and is therefore not cost-effective. For example, the threads 212, the annular grooves 213, and the annular protrusions 214 of the two longitudinal ends of the locating tube 21 can not be made with precision and ease at a reasonable cost. In addition, the two longitudinal ends of the locating tube 21 are susceptible to deformation or severance, especially at the portions where the annular grooves 213 are located.

The plastic wheel rim 10 has a smooth slot for mounting the rubber tire 30. As a result, the rubber wheel 30 is vulnerable to spinning because of lack of friction between the rubber wheel 30 and the wheel rim 10.

### BRIEF SUMMARY OF THE INVENTION

The primary objective of the present invention is to provide a bicycle combination structure comprising a wheel axle assembly and a plastic wheel rim mounted on, the wheel axle assembly.

The wheel axle assembly is formed of a main shaft tube and a pivoting member. The plastic wheel rim is mounted on the main shaft tube by injection molding. The main shaft tube is provided in the midsegment with a plurality of through holes via which a plastic inner tube is formed in the inner wall of the main shaft tube at the time when the plastic wheel rim is formed on the main shaft tube by injection molding. The plastic wheel rim is firmly held on to the main shaft tube by the inner tube serving as an anchorage. The inner tube is provided at both longitudinal ends with a stop ring to locate a bearing disk. The plastic wheel rim is provided in the peripheral surface with a plurality of projections for retaining a rubber tire which is mounted on the plastic wheel rim.

The features and the advantages of the present invention will be more readily understood upon a thoughtful deliberation of the following detailed description of a preferred embodiment of the present invention with reference to the accompanying drawings.

### BRIEF DESCIPTION OF THE SEVERAL VIEWS OF THE DRAWINGS

FIG. 1 shows a schematic perspective view of a bicycle wheel structure of the prior art.

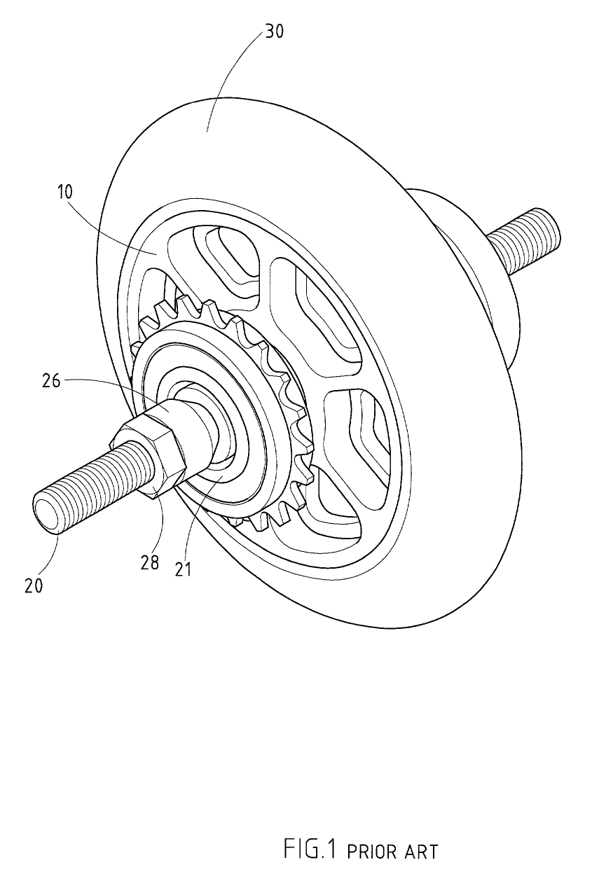

FIG. 2 shows a perspective view of the locating tube of the bicycle wheel structure of the prior art.

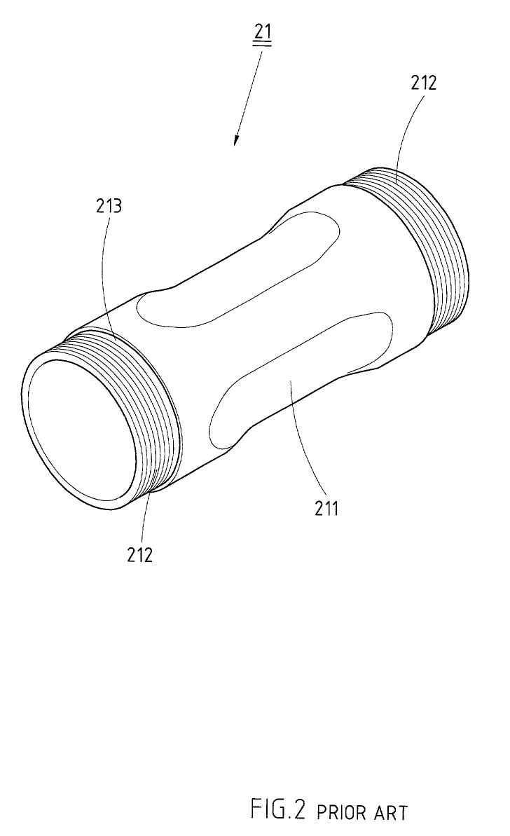

FIG. 3 shows a sectional view of the prior art bicycle wheel structure as shown in FIG. 1.

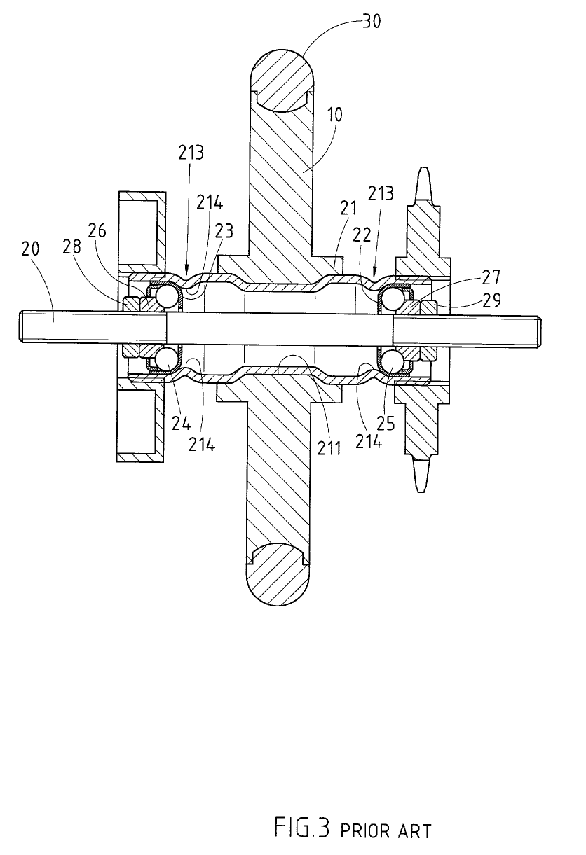

FIG. 4 shows a schematic perspective view of a bicycle wheel structure of the preferred embodiment of the present invention.

FIG. 5 shows an exploded view of the bicycle wheel structure of the preferred embodiment of the present invention.

FIG. 6 shows a partial sectional view of the bicycle wheel structure of the preferred embodiment of the present invention in combination.

FIG. 7 shows a complete sectional view of the bicycle wheel structure of the preferred embodiment of the present invention in combination.

### DETAILED DESCRIPTION OF THE INVENTION

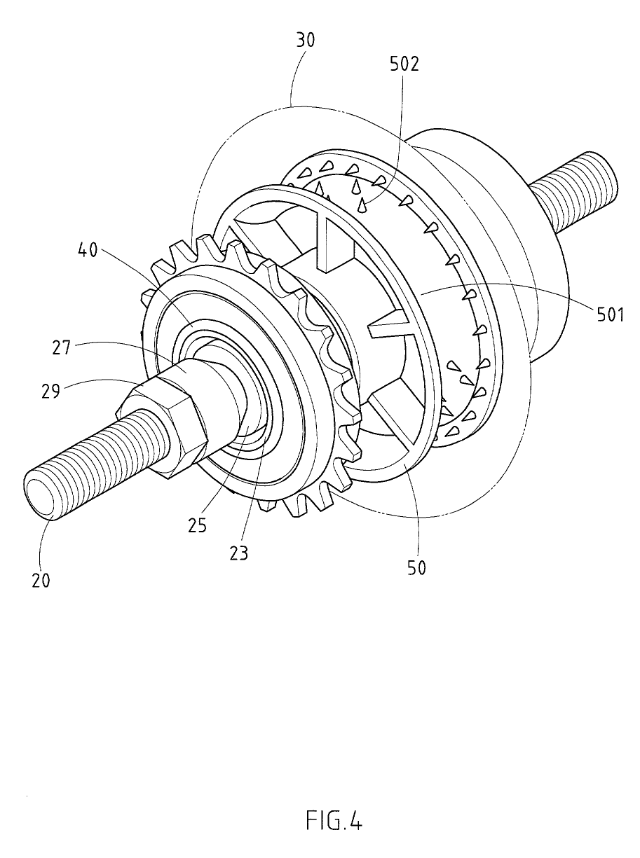

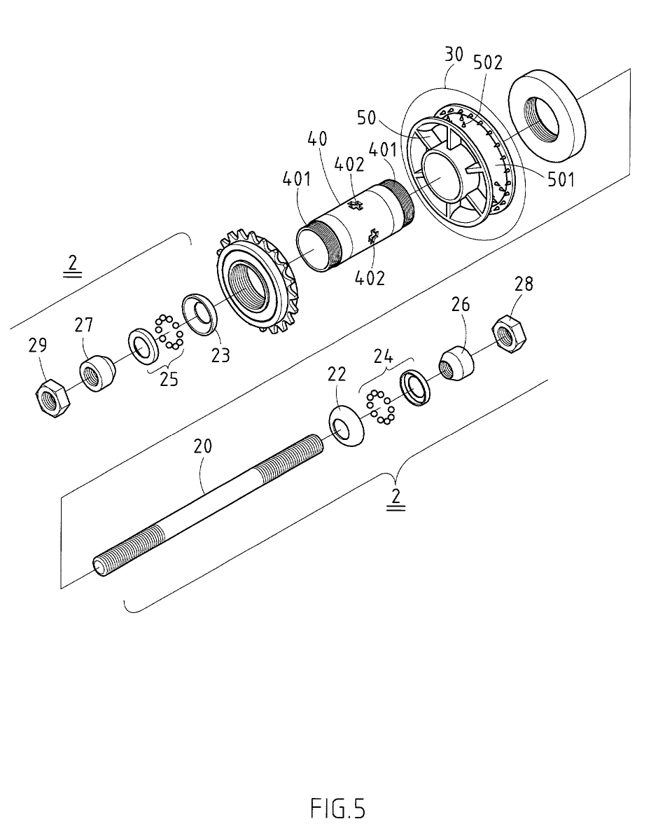

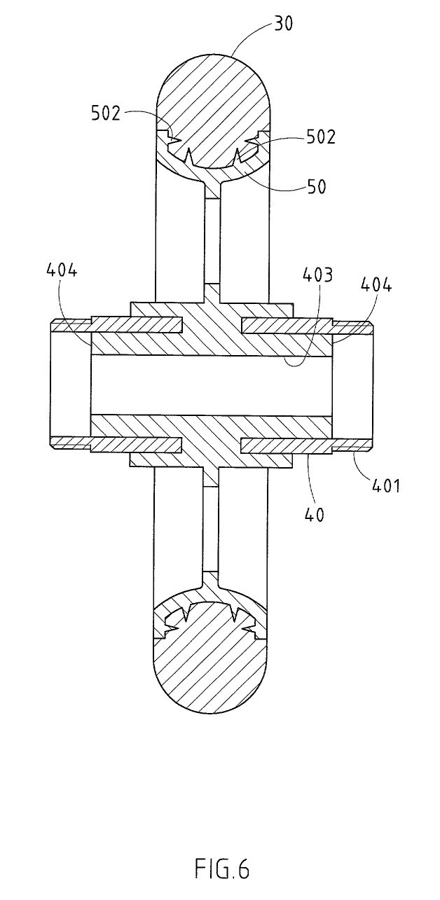

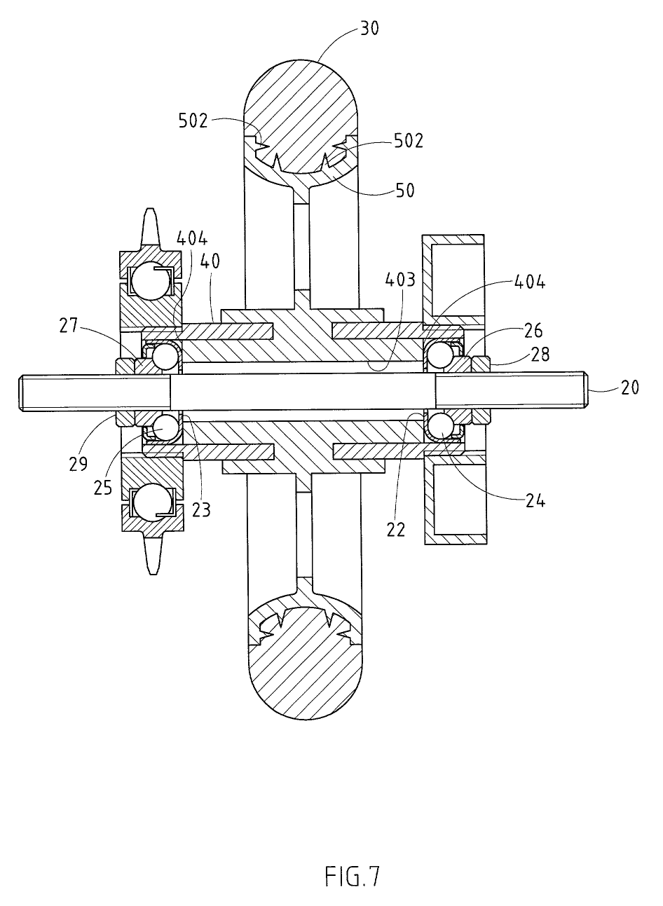

As shown in FIGS. 4-7, a bicycle wheel structure embodied in the present invention comprises a shaft 20, a shaft pivoting member 2, a main shaft tube 40, a wheel rim 50 of a plastic material, and a tire 30.

The shaft 20 is received in the main shaft tube 40 in conjunction with the shaft pivoting member 2 which is formed of two bearing disks 22, 23, two ball bearings 24, 25, two bearings 26, 27, and two nuts 28, 29. The two bearing disks 22 and 23 are mounted on two longitudinal ends of the shaft 20 such that the two bearing disks 22 and 23 are forced into the two longitudinal ends of the main shaft tube 40 in conjunction with the ball bearings 24 and 25. The shaft 20 is held securely in place in the main shaft tube 40 by the bearings 26, 27, and the fastening nuts 28, 29. The main shaft tube 40 is provided at two ends with outer threads 40 1.

The plastic wheel rim 50 is formed on the main shaft tube 40 by injection molding and is provided in the periphery with a tire-receiving slot 501 which is intended to facilitate the mounting of a tire 30 on the plastic wheel rim 50.

The present invention is characterized by the main shaft tube 40 which is provided in the wall of the midsegment thereof with a plurality of through holes 402. In the process of forming the plastic wheel rim 50 on the midsegment of the main shaft tube 40 by injection molding, the plastic material is allowed to flow into the interior of the main shaft tube 40 via the through holes 402 such that the plastic material forms an inner tube 403 on the inner wall of the main shaft tube 40, and that the inner tube 403 is provided at two longitudinal ends thereof with a stop ring 404 which is located in proximity of one of the two longitudinal ends of the main shaft tube 40. The plastic wheel rim 50 is firmly held on to the main shaft tube 40 by means of the inner tube 403 which serves as an anchorage. The inner tube 403 is provided at the longitudinal ends with the stop rings 404 in place of the annular protrusions 214 of the locating tube 21 of the prior art bicycle wheel structure. As a result, the service life span of the main shaft tube 40 of the present invention is effectively prolonged. In addition, the stop rings 404 of the inner tube 403 serve well to prevent the bearing disks 22 and 23 from being forced into the interior of the main shaft tube 40 by an external force.

The tire-receiving slot 501 of the plastic wheel rim 50 of the present invention is provided in the inner wall with a plurality of projections 502, which are intended to retain the tire 30 mounted in the tirereceiving slot 501.

The embodiment of the present invention described above is to be regarded in all respects as being merely illustrative and nonrestrictive. Accordingly, the present invention may be embodied in other specific forms without deviating from the spirit thereof. The present invention is therefore to be limited only by the scope of the following claim.

I claim:

1. A bicycle wheel structure comprising:
a main shaft tube of a hollow construction and having a predetermined length;
a shaft greater in length than said main shaft tube and received in a hollow interior of said main shaft tube in conjunction with a shaft pivoting member which is formed of two bearing disks, two ball bearings, two bearings, and two fastening nuts, with said two bearing disks being mounted on two longitudinal ends of said shaft such that said two bearing disks are forced into two longitudinal ends of said main shaft tube in conjunction with said ball bearings, said shaft being held securely in place in said main shaft tube by said two bearings and said two fastening nuts;
a plastic wheel rim formed on said main shaft tube by injection molding and provided in a periphery with a receiving slot extending throughout the periphery; and
a wheel tire mounted in said receiving slot of said wheel rim;
wherein said main shaft tube is provided in the side wall with a plurality of through holes in communication with the hollow interior of said main shaft tube whereby said through holes enable a plastic material to enter the hollow interior of said main shaft tube to form an inner tube on the inner wall of said main shaft tube at the time when said wheel rim is formed of the plastic material on said main shaft tube by injection molding, said plastic wheel rim being firmly held on to said main shaft tube by said inner tube which serves as an anchorage, said inner tube being provided at two longitudinal ends thereof with a stop ring to prevent said bearing disk from being forced into the interior of said main shaft tube by an external force;
wherein said receiving slot of said plastic wheel rim is provided in the inner wall with a plurality of projections for retaining said wheel tire which is mounted in said receiving slot.
